(19) United States
(12) Patent Application Publication
(10) Pub. No.: US 2021/0308940 A1
(43) Pub. Date: Oct. 7, 2021

(54) ADDITIVE PRODUCTION DEVICE AND ASSOCIATED ADDITIVE PRODUCTION METHOD

(71) Applicant: EOS GmbH Electro Optical Systems, Krailling (DE)

(72) Inventors: Stefan Paternoster, Andechs (DE); Albert Fruth, Germering (DE)

(73) Assignee: EOS GmbH Electro Optical Systems, Krailling (DE)

(21) Appl. No.: 17/267,633

(22) PCT Filed: Aug. 13, 2019
(86) PCT No.: PCT/EP2019/071731

§ 371 Date: Feb. 10, 2021

(30) Foreign Application Priority Data
Aug. 14, 2018 (DE) 10 2018 213 675.0

(51) Int. Cl. B29C 64/153; B29C 64/273; B29C 64/286; B28B 1/00; B33Y 10/00; B33Y 30/00; B33Y 70/00

(52) U.S. Cl. CPC B29C 64/153; B29C 64/273; B29C 64/286; B29K 2077/00; B33Y 10/00; B33Y 30/00; B33Y 70/00; B28B 1/001

(57) ABSTRACT

An additive manufacturing apparatus for manufacturing a three-dimensional object comprises a layer application device (16) for applying a building material layer by layer, an energy input unit (20) which comprises a carbon monoxide laser (21) and a radiation supply unit for supplying laser radiation of the carbon monoxide laser to positions in each layer that are assigned to the cross-section of the object in this layer, and a laser power modification device (27) adapted to effect an increase of the power per unit area incident on the building material within a time period that is smaller than 300 μs and/or larger than 50 ns, when the laser power is increased and/or to effect a reduction of the power per unit area incident on the building material within a time period that is smaller than 100 μm and/or larger than 100 ns, when the laser power is decreased.

The invention refers to an additive manufacturing apparatus, a related additive manufacturing method and a model that has been manufactured by the same.

Additive manufacturing apparatuses and related methods (also referred to as “additive manufacturing”) are generally characterized by the fact that objects are manufactured in them layer by layer by solidifying a shapeless building material. The solidification can be effected, for example, by supplying thermal energy to the building material by irradiating it with electromagnetic radiation or particle radiation (e.g. laser sintering or laser melting or electron beam melting). In laser sintering or laser melting, for example, the area of incidence of a laser beam on a layer of the building material is moved across those positions of the layer which correspond to the object cross-section of the object to be produced in this layer.

When a plastic powder (polymer powder) is chosen as building material, usually a solidification of the building material is effected by an irradiation with a CO₂ laser. The latter emits radiation having a wavelength of 10.6 μm and is used in particular because most polymer materials absorb well radiation of a wavelength of 10.6 μm.

As the size of the focus of the radiation on the building material depends on the wavelength, the detail resolution that can be obtained for the manufactured objects is the better the smaller the wavelength of the radiation used for a solidification. Due to the poor absorption of wavelengths shorter than 10.6 μm by polymer materials, DE 199 18 981 A1 suggests mixing the building material with an absorber which absorbs laser radiation having a wavelength of 500 to 1500 nm so that also a laser emitting in this wavelength range such as a Nd-YAG or a Nd-YLF laser may be used and a better resolution of details can be achieved.

However, the use of absorber additives brings about a number of disadvantages. On the one hand, the process costs will rise due to the costs of the material of the absorber additives and due to the need for a homogenous mixing of the absorber additives with the building material and for applying the absorber additives onto a layer of the building material, respectively. Furthermore, the process window, meaning the temperature range that is available for a stable process conduct will shrink. Moreover, the process control is more difficult as inhomogeneities of the amount of absorber may lead to inhomogeneities in the manufactured object and its surface, respectively. Finally, it is more difficult to obtain objects having a desired color: A dark absorber such as carbon black leads to dark objects that can be re-colored only by an increased effort, e.g. when light objects are desired in which the dark color does not gleam.

Therefore, the object of the present invention is the provision of a laser-based additive manufacturing apparatus and a related additive manufacturing method by means of which objects having a higher resolution of details can be additively manufactured without additional disadvantages.

The object is achieved by an additive manufacturing apparatus according to claim 1, an additive manufacturing method according to claim 8 and an article according to claim 14. Further developments of the invention are claimed in the dependent claims. In particular, an apparatus according to the invention may also be developed further by features of the methods according to the invention that are mentioned further below and in the dependent claims, respectively, and vice versa. Moreover, the features described in connection with an apparatus can also be used for the further development of another apparatus according to the invention, even if this is not explicitly stated.

An inventive additive manufacturing apparatus for manufacturing a three-dimensional object comprises:
a layer application device for applying a building material layer by layer,
an energy input unit which comprises
   a carbon monoxide laser and
   a radiation supply unit for supplying laser radiation of the carbon monoxide laser to positions in each layer that are assigned to the cross-section of the object in this layer,

and
a laser power modification device (27) adapted to effect an increase of the power per unit area incident on the building material within a time period that is smaller than 300 μs and/or larger than 50 ns, when the laser power is increased and/or to effect a reduction of the power per unit area incident on the building material within a time period that is smaller than 100 μm and/or larger than 100 ns, when the laser power is decreased.

In additive manufacturing apparatuses and methods to which the present invention refers, energy is selectively supplied to a layer of the building material in the form of laser radiation. Here, the radiation impinges on the building material in a working plane, which usually is a plane in which the top side of the layer facing the energy input unit is located. The material heats up due to the supplied energy, whereby the building material is sintered or melted.

It shall be mentioned here that by means of an additive manufacturing apparatus not only one object, but also several objects can be manufactured at the same time. If in the present application the manufacturing of an object is mentioned, then it goes without saying that the corresponding description is applicable in the same way also to additive manufacturing methods and apparatuses in which several objects are manufactured at the same time.

With respect to the design of the layer application device in the additive manufacturing apparatus according to the invention there are no limitations. Each layer application device known in the field of additive manufacturing that is adapted to apply a building material layer-wise, i.e. layer upon layer, can be a component of the additive manufacturing apparatus. The layer application device needs only to be adapted to apply a shape-less building material, in particular a powder, wherein often a plane surface of an applied layer is established by means of a leveling device and a constant distance between the energy input unit and the building material is achieved thereby.

In particular, the layer application device is able to handle a polymer-containing building material, meaning in particular a plastic powder or a powder that has a plastic content that shall be melted by the supply of energy.

The carbon monoxide layer may be a commercially available laser. Usually, the radiation emitted by a carbon monoxide laser lies in the range between 4 and 8 μm, for example between 5 and 6 μm. The basic designs of the radiation supply units that can be used can be the same as those that are used in the field of additive manufacturing when CO₂ lasers are used. A radiation supply unit usually contains a beam deflection unit by means of which the laser radiation is directed onto a layer of the building material.

The laser power modification device that is present according to the invention is characterized by being able, when it is correspondingly controlled, to change the laser power supplied to the building material within a short period of time, meaning in particular the power per unit area impinging onto the building material. Here, the time specified for an increase of the power refers to the difference between the times at which the existent laser power has increased by 10% and 90%, respectively, of the amount of the difference in power. Here, the amount of the difference in power refers to the difference between the laser power per unit area supplied to the building material after the power has been increased and the laser power per unit area supplied to the building material before the power has been increased. In the same way, the time specified for a reduction of the power refers to the difference between the times at which the existent laser power has decreased by 10% and 90%, respectively, of the amount of the difference in power. Here, the amount of the difference in power refers to the difference between the laser power per unit area supplied to the building material after the decrease of the power and the laser power per unit area supplied to the building material before the decrease of the power.

Preferably, a continuous wave laser (cw laser) is used in the present invention. In other words, preferably no quality modulation (Q-switching) of the laser resonator occurs. The advantage of continuous wave lasers lies in the fact that they have narrow lines so that possibly a better absorption in the material results.

In this respect it shall be emphasized that the laser power modification device is arranged in the beam path downstream the carbon monoxide laser. In other words, the laser power modification device is not a constituent of the carbon monoxide laser but modifies the power of the laser radiation only after the radiation has exited the carbon monoxide laser. Thus, a laser power modification device is explicitly not understood to be a control device of a carbon monoxide laser. Rather, by means of the laser power modification device it becomes possible to provide for a fast increase or decrease of the irradiance, when the radiant power supplied to the building material is increased or decreased. Accordingly, this does not refer to pulse rise times or pulse fall times of a pulsed laser.

It was found that the radiation emitted by a carbon monoxide laser is very well absorbed by polymer materials such as polyamide so that the use of absorber materials can be abandoned. At the same time a better resolution of details can be obtained due to the smaller wavelengths as compared to the carbon dioxide laser. Furthermore, due to the smaller beam focus it is possible to arrive at better surfaces of the manufactured objects, in particular a smaller surface roughness.

Usually, carbon monoxide lasers cannot be switched on and off as quickly as carbon dioxide lasers. However, due to the laser power modification device that is present according to the invention, the carbon monoxide laser can be switched with the same speed and even a considerably higher speed than a carbon dioxide laser. As during the selective solidification of a building material layer the laser beam usually has to be switched on and off very often, for a rapid manufacture of objects by means of additive manufacturing it is therefore important that according to the invention no concessions in terms of speed of the manufacturing process have to be made, though the advantages of using a short wavelength radiation can be utilized.

Preferably, the laser power modification device is an acousto-optic or electro-optic modulator.

The mentioned modulators are particularly suitable for effecting fast switching processes, in particular a fast switching or change of the laser radiation supplied to the building material.

Further preferably, the zeroth order laser radiation penetrating the laser power modification device is supplied to the positions in each layer that are assigned to the cross-section of the object in this layer in order to solidify the building material.

With this mode of operating the acousto-optic or electro-optic modulator, a beam deflection of the laser light penetrating the modulator, which laser light shall be supplied to the building material, does not occur. This eliminates errors that may result from changes of the deflection angle and makes the adjustment simpler. When the supply of radiation is switched off, in essence energy is shifted from the zeroth order to the higher orders.

The inventors found that when the supply of radiation is switched off, residual light still present in the zeroth order can be tolerated even when the building material is a polymer-containing building material. When a polymer-containing building material is used in the additive manufacturing of objects, usually the building material is heated by means of a radiant heater up to a work temperature just below the melting point. Then, only the missing additional energy for a melting of the material is supplied by the laser radiation. Though one might therefore assume that residual light that is present leads to an undesired melting of building material, it turned out that such an undesired melting can be avoided when polymer-containing building material is used, if either one takes care that the “switched off” laser beam is not directed for a too long time to the same position of the building material or else the work temperature is lowered slightly. When metal-based building material is used, in particular steel powder, the residual light that is present is non-critical as in these cases a considerable percentage of the energy necessary for a melting is supplied by the laser radiation similar as in laser machining.

Further preferably, the radiation supply unit in the additive manufacturing apparatus comprises a deflection unit adapted to direct laser radiation of the carbon monoxide laser to positions in each layer that are assigned to the cross-section of the object in this layer and/or
a focusing unit adapted to focus laser radiation of the carbon monoxide laser on the surface of a building material layer,
wherein a characteristic dimension, in particular an aperture size of the deflection and/or focusing unit, is equal to or smaller than approximately 50 mm, preferably equal to or smaller than approximately 20 mm, particularly preferably equal to or smaller than approximately 10 mm and/or equal to or larger than 5 mm.

As already mentioned, a smaller focus diameter can be achieved due to the wavelength that is reduced as compared to the CO₂ laser. This implies that also an aperture size of the radiation supply unit can be made smaller. This again implies that the dimensions of the optical elements such as the rotating mirrors in a beam deflection device can be made smaller. For a beam deflection device this means concretely that due to the smaller dimensions of the rotating mirrors their inertial masses are also smaller which results in a higher acceleration for rotational movements. When during the movement of a laser beam used for the solidification across the building material the movement is changed, the finite acceleration time, which exists in practice due to the inertial masses of the rotational mirrors, causes a mismatch between the current position of the beam on the building material and the intended position, which mismatch is designated as tracking error. This behavior has in particular an effect at the start and at the end of scanlines and hatch lines, respectively. Due to the higher accelerations of the rotating mirrors in rotational movements that result from the smaller inertial masses, the tracking error can be advantageously kept smaller. As in addition also switching processes for the laser radiation can be made fast, the laser power to be supplied per unit area can also be adapted more precisely to the tracking error. In particular, the representation accuracy (constancy of shapes) will be higher for a given scanning speed. Therefore, the inventive set-up with the described laser power modification device will be advantageous particularly in additive manufacturing apparatuses. In applications in which the article is moved, e.g. in laser cutting or in hole drilling by means of laser radiation, the workpiece carrier together with the workpiece has such a large mass that similarly high accelerations like those when a galvanometer scanner-based deflection device is used cannot be achieved.

Preferably, the additive manufacturing apparatus comprises a focusing unit adapted to generate a focus diameter equal to or smaller than 500 μm, preferably equal to or smaller than 300 μm, further preferably equal to or smaller than 250 μm and/or equal to or larger than 80 μm, more preferably equal to or smaller than 100 μm, further preferably equal to or larger than 150 μm on the surface of a building material layer.

In an additive manufacturing method using such an additive manufacturing apparatus, a high resolution of geometric details of the manufactured objects is achieved due to the small focus diameter. In particular, when using a deflection and/or focusing unit having a small aperture size, a high resolution of details is obtained though a tracking error occurs. Assuming the beam profile to be Gaussian, a focus diameter can be defined as mean diameter or maximum diameter of the area inside of which the beam power is larger than the maximum of the beam power divided by e², where e is Euler's number.

Further preferably, the deflection unit in the additive manufacturing apparatus is adapted to move the laser beam focus with a speed across the surface of the building material that is equal to or larger than 2 m/s and/or equal to or smaller than 50 m/s, preferably equal to or larger than 5 m/s and/or equal to or smaller than 30 m/s, more preferably equal to or larger than 8 m/s and/or equal to or smaller than 25 m/s.

In an additive manufacturing method according to the invention which uses such an additive manufacturing apparatus, the area of incidence of the laser radiation on the building material is moved with high speed as compared to the prior art due to a small aperture size and characteristic dimension, respectively, of the deflection and/or focusing units. Nevertheless, sufficient energy for being able to solidify the building material is supplied due to the wavelength of the radiation. Thus, objects are manufactured in a time period that is smaller than in the prior art without having to tolerate deficiencies in quality, in particular in the resolution of details. For the specified values of the speed it was assumed that the distance between the deflection unit and the rotatable mirror, respectively, and the surface of the building material layer to be selectively solidified is 50 cm.

Preferably, in the additive manufacturing apparatus, the laser beam focus can be moved across the surface of the building materials in hatch lines that are parallel to each other with a distance to one another that is smaller than 0.18 mm, preferably smaller than 0.16 mm, more preferably smaller than 0.14 mm and/or larger than 0.05 mm and/or in which a beam offset can be set that is smaller than 0.18 mm, preferably smaller than 0.16 mm, more preferably smaller than 0.14 mm.

In an additive manufacturing method using such an additive manufacturing apparatus, a smaller diameter of the area of incidence of the laser radiation on the building material layer is obtained as compared to the use of a CO₂ laser due to the use of laser radiation having a smaller wavelength. Accordingly, when scanning the building material by moving the laser beam along scanlines that are in parallel to each other (hatch lines), the distances that the hatch lines have to each other are made smaller. Accordingly, a more homogeneous solidification occurs, so that parts having a higher quality can be obtained. The term “beam offset” is an English-language term which is common in the field of additive manufacturing and specifies the chosen beam offset at the contour of an object cross-section. By this beam offset, which usually is perpendicular to the contour, it is achieved that the outer dimension of the object to be manufactured, which outer dimension is specified in the model data, is realized as exactly as possible at the manufactured object when the contour is scanned, though the diameter of the area of incidence of the radiation on the building material is finite.

In an inventive additive manufacturing method for manufacturing a three-dimensional object a building material is applied layer on layer and by means of an energy input unit that comprises a carbon monoxide laser and a radiation supply unit, laser radiation of the carbon monoxide laser is supplied by the radiation supply unit to positions in each layer that are assigned to the cross-section of the object in this layer. Furthermore, by means of a laser power modification device, an increase of the power per unit area incident on the material is effected within a time period that is smaller than 300 μs and/or larger than 50 ns, when the laser power is increased, and/or a reduction of the power per unit area incident on the building material is effected within a time period that is smaller than 300 μs and/or larger than 50 ns, when the laser power is reduced.

By the additive manufacturing method according to the invention the same advantages are achieved that result from the use of the additive manufacturing apparatus according to the invention.

Preferably, in the additive manufacturing method according to the invention the building material is substantially free from absorbers. The term “free from absorbers” here expresses the fact that virtually no materials have been added to the building material that are suitable for increasing the absorption of the laser radiation. In particular, one does completely abandon the specific use of additives for increasing the absorption of laser radiation. On the one hand, this refers to the fact that the building material is not mixed with absorber additives. On the other hand, any absorber is also not applied on a building material layer before the same is solidified. As already mentioned, an additive manufacturing process is simpler if one does without the use of absorber additives. Moreover, there are fewer restrictions regarding the color of the objects as light objects in particular can be obtained without problems.

The additive manufacturing method according to the invention and the additive manufacturing apparatus according to the invention lead to advantages in all additive manufacturing processes in which a building material is used that absorbs well the radiation of the carbon monoxide laser. However, preferably, the building material contains a polymer, preferably in the form of a polymer powder, and/or coated sand and/or a ceramic material, preferably in the form of a ceramic powder. It appeared that polymers, in particular PA11 and PA12, do absorb the radiation of a carbon monoxide laser to a great extent. No previous use of a carbon monoxide laser for melting polymers is known to the inventors, in particular in the field of additive manufacturing.

Further preferably, the building material comprises a polymer-containing material and in particular a polyamide, polypropylene (PP), polyether imide, polycarbonate, polyphenylene sulfone, polyphenylene oxide, polyether sulfone, acrylonitrile butadiene styrene copolymerisate, polyacrylate, polyester, polyurethane, polyimide, polyamide imide, polyolefin, polystyrene, polyphenylene sulfide, polyvinylidene fluoride, polyamide elastomer, polyether ether ketone (PEEK) or polyaryletherketone (PAEK).

For example, the building material in powder form can contain at least one of the polymers selected from the group formed of the following polymers: polyether imides, polycarbonates, polyphenylene sulfones, polyphenylene oxides, polyether sulfones, acrylonitrile butadiene styrene co-polymerisates, polyacrylates, polyesters, polyamides, polyaryletherketones, polyethers, polyurethanes, polyimides, polyamide imides, polyolefins, polystyrenes, polyphenylene sulfides, polyvinylidene fluorides, polyamide elastomers such as polyether block amides as well as co-polymers, which contain at least two different monomer units of the before mentioned polymers. Suitable polyester polymers or co-polymers can be selected from the group consisting of polyalkylene terephthalates (e.g. PET, PBT) and their co-polymers. Suitable polyolefin polymers or co-polymers can be selected from the group consisting of polyethylene and polypropylene. Suitable polystyrene polymers or co-polymers can be selected from the group consisting of syndiotactic and isotactic polystyrenes. The building material in powder form can additionally or alternatively contain at least one polyblend based on at least two of the before mentioned polymers and co-polymers. Here, with the polymer as matrix, additional additives can be present, e.g. free-flowing agents, fillers, pigments, etc., however, preferably no absorber additives.

Further preferably, a solidified area in the area of incidence of the laser radiation on the building material has a dimension in the layer plane that is less than approximately 300 μm, preferably less than approximately 250 μm, particularly preferably less than approximately 200 μm.

Compared to the use of a CO₂ laser of the same aperture size, it is possible to obtain a smaller diameter of the area of incidence of the laser radiation on the building material layer due to the use of laser radiation having a smaller wavelength. As a result, details with smaller dimensions can be realized by means of additive manufacturing as compared to the use of a CO₂ laser.

Preferably, the layers of the building material are applied with a thickness of less than 80 μm, preferably less than 60 μm, further preferably less than 50 μm and/or a thickness of 10 μm or more, more preferably 25 μm or more.

Due to the use of laser radiation having a smaller wavelength, a smaller aperture size and characteristic dimension, respectively, in the deflection and/or focusing unit than in the prior art can be used. In particular, due to the smaller size and resulting smaller mass of galvanometer mirrors used as deflection unit, the area of incidence of the laser radiation on the building material can be moved with a higher speed as compared to the prior art. Accordingly, objects can be manufactured within a period of time that is shorter as compared to the prior art. This is utilized for obtaining objects with an improved resolution of details perpendicular to the building material layers. For this, building material layers of a smaller thickness are applied and solidified, respectively. Though by this the total number of building material layers to be applied and to be solidified for a manufacture of the object increases, the manufacturing time remains reasonable due to the higher movement speed of the area of incidence of the radiation.

An article that has been manufactured by an inventive additive manufacturing method from a building material that is substantially free from absorbers, in particular free from carbon black, has at least one dimension of a detail, in particular a wall thickness, that is equal to or smaller than 150 μm and/or equal to or larger than 50 μm, preferably equal to or larger than 100 μm.

An article that has been manufactured according to an additive manufacturing method according to the invention can have details with smaller dimensions, though the use of absorber additives has been dispensed with.

Preferably, the article, which is made in particular of polyamide, polypropylene (PP), polyether imide, polycarbonate, polyphenylene sulfone, polyphenylene oxide, polyether sulfone, acrylonitrile butadiene styrene copolymerisate, polyacrylate, polyester, polyurethane, polyimide, polyamide imide, polyolefin, polystyrene, polyphenylene sulfide, polyvinylidene fluoride, polyamide elastomer, polyether ether ketone (PEEK) or polyaryletherketone (PAEK), comprises less than 0.01 wt.-% absorber material.

As already mentioned further above, by the additive manufacturing method according to the invention, in particular articles made of a plastic-containing material can be obtained. The abandonment of absorber additives can also be recognized at the manufactured articles themselves, which for example are free from carbon black and therefore can be obtained in a lighter color without the effort of a post-coloring.

Further features and practicalities of the invention will arise from the description of embodiments based on the attached drawings.

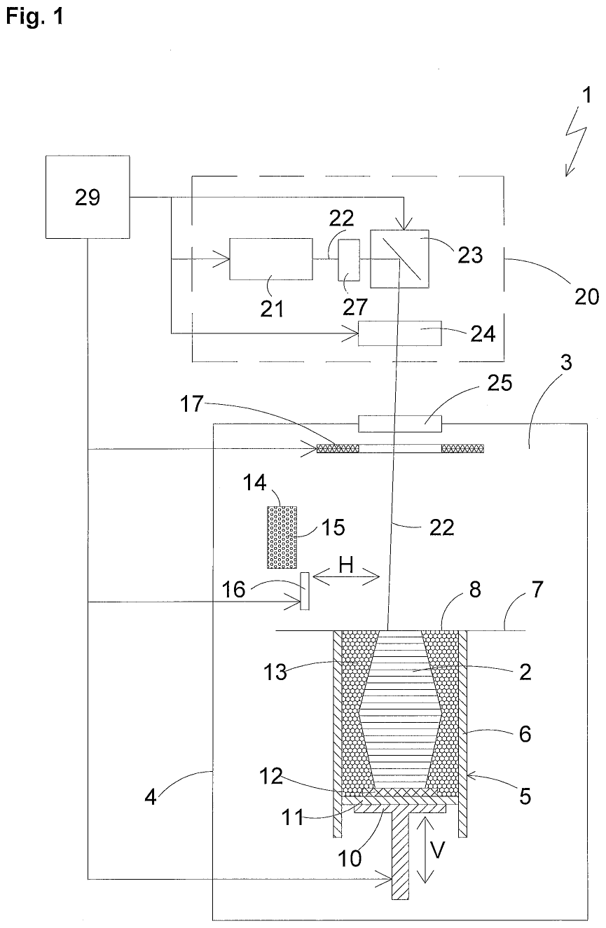

FIG. 1 shows a schematic, partially sectional view of an exemplary apparatus for an additive manufacture of a three-dimensional object according to the invention.

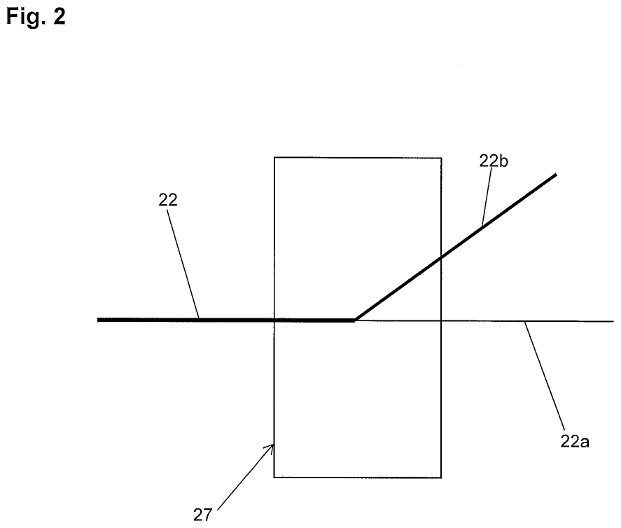

FIG. 2 is for the purpose of schematically illustrating the manner of use of an acousto-optic modulator used as laser power modification device in the context of the present invention.

For building an object 2, the laser sintering or laser melting apparatus 1 comprises a process chamber or build chamber 3 having a chamber wall 4. A build container 5 which is open at the top and which has a container wall 6 is arranged in the process chamber 3. The top opening of the container 5 defines a working plane 7, wherein the area of the working plane 7 located within the opening, which area can be used for building the object 2, is referred to as build area 8.

In the build container 5, a support 10 is arranged that can be moved in a vertical direction V and to which a base plate 11 is attached which seals the container 5 at the bottom and thus forms the bottom thereof. The base plate 11 can be formed as a plate separately from the support 10, which plate is fixed to the support 10, or it can be integrally formed with the support 10. Depending on the powder and process used, a building platform 12 as building support can be additionally arranged on the base plate 11, on which building platform 12 the object 2 is built. However, the object 2 can also be built on the base plate 11 itself, which then serves as a building support. In FIG. 1, the object 2 to be formed in the container 5 on the building platform 12 is shown below the working plane 7 in an intermediate state with several solidified layers, surrounded by building material 13 that remained unsolidified.

The laser sintering or melting device 1 further comprises a storage container 14 for a building material 15, in this example a powder that can be solidified by electromagnetic radiation, and a recoater 16 as material application device that can be moved in a horizontal direction H for applying the building material 15 within the build area 8. Optionally, a heating device, e.g. a radiant heater 17, can be arranged in the process chamber 3, which heating device serves for a heating of the applied building material. For example, an infrared heater may be provided as radiant heater 17.

The exemplary additive manufacturing apparatus 1 further comprises an energy input unit 20 having a carbon monoxide laser 21 generating a laser beam 22 that is deflected by a deflection device 23 and is focused on the working plane 7 through a coupling window 25 that is arranged at the top side of the process chamber 3 in the chamber wall 4 by a focusing device 24. For example, the laser distributed by the company Coherent under the name “DIAMOND J-3-5 CO Laser” can be used as carbon monoxide laser.

The deflection device 23 substantially consists of a galvanometer mirror for a deflection into each of the X direction and the Y direction, wherein it is assumed that the working plane 7 extends in the X direction and Y direction. In particular, a laser power modification device 27, which in the present example is an acousto-optic modulator, is located in the beam path between the carbon monoxide laser 21 and the deflection device 23. Such modulators are for example distributed by the company Gooch & Housego PLC in Ilminster UK. For example, the model I-MOXX-XC11B76-P5-GH105 can be driven with up to 60 MHz.

FIG. 2 shows in detail the manner of use of the acousto-optic modulator in the present example. The laser beam 22 emitted by the carbon monoxide laser 21 is split up in the acousto-optic modulator 27 into a beam 22a supplied to the deflection device 23 and a beam 22b. In the present example, the beam 22a is the zeroth order of the diffraction pattern and the beam 22b is the first order of the diffraction pattern. Of course, also higher orders occur. However, these are not shown in order to simplify the drawing. It can be seen that in the present example the laser power modification device 27 serves for attenuating the beam 22 emitted by the carbon monoxide laser 21 in order to modulate thereby its power. Here, the beam 22a supplied to the deflection device 23 propagates in the same direction as the beam 22 emitted by the carbon monoxide laser 21. Thus, even if variations of the environmental conditions lead to variations in the behavior of the acousto-optic modulator, this has no effect on the direction of the beam supplied to the deflection device 23. By means of the shown arrangement, the power in the beam 22 is substantially deflected into the higher orders for switching off the beam in order to obtain as few power as possible in the zeroth order. Thus, by a control of the acousto-optic modulator 27, the beam supplied to the deflection device 23 is substantially switched on and off. The power still remaining in the zeroth order in a switch-off lies in the range of few percent and can be tolerated as it is usually not able to effect an undesired solidification of the building material. The presence of residual light of the beam source used for the solidification is known in the prior art and is named there “bleeding”.

Furthermore, the laser sintering apparatus 1 comprises a control unit 29 by which the individual components of the apparatus 1 can be controlled in a coordinated manner in order to implement the building process. Alternatively, the control unit can also be arranged partially or completely outside of the additive manufacturing apparatus. The control unit can comprise a CPU, the operation of which is controlled by a computer program (software). The computer program can be stored separately from the additive manufacturing apparatus on a storage device from where it can be loaded (e.g. via a network) into the additive manufacturing apparatus, in particular into the control unit.

In operation, the control unit 29 lowers the support 10 layer by layer, it activates the recoater 16 for applying a new powder layer and the laser power modification device 27, the deflection device 23 and, if necessary, also the laser 21 and/or the focusing device 24 for solidifying the respective layer at the positions corresponding to the respective object by means of the laser by scanning these positions with the laser.

In the additive manufacturing apparatus just described as an example, a manufacturing process is carried out in such a way that the control unit 29 processes a control data set.

For each point in time during the solidification process, the control data set instructs an energy input unit, in the case of the above laser sintering or laser melting apparatus specifically the deflection device 23, to which position on the working plane 7 the radiation is to be directed.

As mentioned further above, instead of the acousto-optic modulator also a different optical device can be used as laser power modification device provided that it is adapted to change the laser power supplied to the building material, meaning in particular the power impinging per unit area onto the building material, within a short period of time. For example, also a photo-elastic modulator (PEM) that can be controlled correspondingly fast or an adequate wave plate (e.g. λ/2 plate) together with a polarizer can be used.

1. An additive manufacturing apparatus for manufacturing a three-dimensional object comprises:
a layer application device for applying a building material layer by layer,
an energy input unit which comprises
a carbon monoxide laser and
a radiation supply unit for supplying laser radiation of the carbon monoxide laser to positions in each layer that are assigned to the cross-section of the object in this layer, and
a laser power modification device adapted to effect an increase of the power per unit area incident on the building material within a time period that is smaller than 300 μs and/or larger than 50 ns, when the laser power is increased and/or to effect a reduction of the power per unit area incident on the building material within a time period that is smaller than 100 μm and/or larger than 100 ns, when the laser power is decreased.

2. The additive manufacturing apparatus of claim 1, wherein the laser power modification device is an acousto-optic or electro-optic modulator.

3. The additive manufacturing apparatus of claim 2, wherein the zeroth order laser radiation penetrating the laser power modification device is supplied to the positions in each layer that are assigned to the cross-section of the object in this layer in order to solidify the building material.

4. The additive manufacturing apparatus of claim 1, wherein the radiation supply unit comprises a deflection unit adapted to direct laser radiation of the carbon monoxide laser to positions in each layer that are assigned to the cross-section of the object in this layer and/or
a focusing unit adapted to focus laser radiation of the carbon monoxide laser on the surface of a building material layer,
wherein a characteristic dimension is equal to or smaller than approximately 50 mm and/or equal to or larger than 5 mm.

5. The additive manufacturing apparatus according to claim 4, comprising a focusing unit adapted to generate a focus diameter equal to or smaller than 500 μm on the surface of a building material layer.

6. The additive manufacturing apparatus according to claim 4, wherein the deflection unit is adapted to move the laser beam focus with a speed across the surface of the building material that is equal to or larger than 2 m/s and/or equal to or smaller than 50 m/s.

7. The additive manufacturing apparatus according to claim 1 in which the laser beam focus can be moved across the surface of the building materials in hatch lines that are parallel to each other with a distance to one another that is smaller than 0.18 mm and/or in which a beam offset can be set that is smaller than 0.18 mm.

8. An additive manufacturing method for manufacturing a three-dimensional object, wherein
a building material is applied layer on layer and
by means of an energy input unit that comprises a carbon monoxide laser and a radiation supply unit laser radiation of the carbon monoxide laser is supplied by the radiation supply unit to positions in each layer that are assigned to the cross-section of the object in this layer, and
by means of a laser power modification device an increase of the power per unit area incident on the material is effected within a time period that is smaller than 300 μs and/or larger than 50 ns, when the laser power is increased, and/or a reduction of the power per unit area incident on the building material is effected within a time period that is smaller than 300 μs and/or larger than 50 ns, when the laser power is reduced.

9. The additive manufacturing method according to claim 8, wherein the building material is substantially free from absorbers.

10. The method according to claim 8, wherein the building material contains a polymer and/or coated sand and/or a ceramic material.

11. The method according to claim 8, wherein the building material includes at least one member from the group consisting of a polyamide, polypropylene (PP), polyether imide, polycarbonate, polyphenylene sulfone, polyphenylene oxide, polyether sulfone, acrylonitrile butadiene styrene copolymerisate, polyacrylate, polyester, polyurethane, polyimide, polyamide imide, polyolefin, polystyrene, polyphenylene sulfide, polyvinylidene fluoride, polyamide elastomer, polyether ether ketone (PEEK) and polyaryletherketone (PAEK).

12. The method according to claim 8, wherein a solidified area in the area of incidence of the laser radiation on the building material has a dimension in the layer plane that is less than approximately 300 μm.

13. The method according to claim 8, wherein the layers of the building material are applied with a thickness of less than 80 μm and/or a thickness of 10 μm or more.

14. An article that has been manufactured by the methods according to claim 8 from a building material that is substantially free from absorbers, wherein at least one dimension of a detail is equal to or smaller than 150 μm and/or equal to or larger than 50 μm.

15. The article according to claim 14, which is made from at least member from the group consisting of polyamide, polypropylene (PP), polyether imide, polycarbonate, polyphenylene sulfone, polyphenylene oxide, polyether sulfone, acrylonitrile butadiene styrene copolymerisate, polyacrylate, polyester, polyurethane, polyimide, polyamide imide, polyolefin, polystyrene, polyphenylene sulfide, polyvinylidene fluoride, polyamide elastomer, polyether ether ketone (PEEK) and polyaryletherketone (PAEK), and comprises less than 0.01 wt.-% absorber material.
